(19) United States
(12) Patent Application Publication
(10) Pub. No.: US 2014/0356794 A1
(43) Pub. Date: Dec. 4, 2014

(54) Combustion Chamber Supply Device and Method Thereof

(71) Applicant: ECOMB AB (PUBL), Sodertalje (SE)

(72) Inventor: Ulf Hagstrom, Nykoping (SE)

(73) Assignee: ECOMB AB (PUBL), Sodertalje (SE)

(21) Appl. No.: 14/351,314

(22) PCT Filed: Oct. 11, 2012
(86) PCT No.: PCT/SE2012/051093

§ 371 Date: Apr. 11, 2014

(30) Foreign Application Priority Data
Oct. 12, 2011 (SE) 1150943-7

(51) Int. Cl. F23N 1/02; F27B 7/00; F23D 1/00

(52) U.S. Cl. CPC F23N 1/02; F23D 1/005; F27B 7/00
USPC 431/12; 110/263; 110/104 B; 432/105

(57) ABSTRACT

A supply tube assembly has a central longitudinal axis, a first end and a second end and includes a supply pipe extending in parallel with the central longitudinal axis from the second end of the supply tube assembly to the first end of the supply tube assembly. The supply pipe is open to form a pipe outlet at the first end. The supply pipe is configured for transporting solid particles carried by a fluid from the second end to the pipe outlet. A ramp arranged inside the supply pipe at the pipe outlet and pivotably arranged such that the inclination of the ramp in relation to the longitudinal axis is adjustable by pivoting the ramp about a pivot axis which is perpendicular to the central longitudinal axis, with the ramp extending from said pivot axis towards the pipe outlet.

### TECHNICAL FIELD

The invention relates to a method and a supply device for supplying a fluid and/or solid particles to a combustion chamber.

### BACKGROUND

Generally, heat generating plants, such as boilers, incinerator furnaces and technically corresponding apparatuses are designed to combust or burn different kinds of fuels. Depending on the type of fuel being combusted or burnt, different kinds of hazardous gases and/or particles may be formed or released. The amount of these hazardous gases and/or particles depends, among other things, on how well or completely the fuel is being combusted or burnt. This in turn depends on e.g. the temperature of the grate and the combustion chamber, the amount of available air and other substances that are present to be used by the combustion process and so on. In order to improve the combustion and in order to minimise the pollution/emission caused by the hazardous gases and/or particles, different kinds of supply devices for supplying fluid to an internal combustion chamber of a heat generating plant have been devised.

Supply devices for supplying fluid to an internal combustion chamber of a heat generating plant, such as a boiler, an incinerator furnace and technically corresponding apparatus are known from SE 9201747-4 publication number 502 188 and SE 9304038-4 publication number 502 283, both in the same name of ECOMB, and their foreign counterparts.

These known fluid supply devices provide comparatively low emission levels and great flexibility and enable adjustments to desired emission levels to be achieved quickly and reliably. This is attained by arranging a supply device comprising at least one tube to be inserted horizontally into the combustion chamber.

Other types of supply devices are described in DE 306 765 (Bauer) and U.S. Pat. No. 5,112,216 (Tenn) for example.

Rotary kilns are cylindrical vessels, inclined slightly to the horizontal, which are rotated about its axis. Rotary kilns are used for heat treatment of e.g. cement and lime. The material to be treated is fed into the upper end of the cylinder. As the kiln rotates, the material gradually moves down towards the lower end while being mixed. Hot gases pass along the kiln, co-currently or counter-currently with the treated material. The hot gases may be generated in an external furnace, or may be generated by a flame inside the kiln.

### SUMMARY

It is an objective of the present invention to alleviate a problem of the prior art.

According to an aspect of the present invention, there is provided a supply tube assembly for supplying solid particles to a combustion chamber, said supply tube assembly having a central longitudinal axis, a first end and a second end, the supply tube assembly comprising: a supply pipe extending in parallel with the central longitudinal axis from the second end of the supply tube assembly to the first end of the supply tube assembly, the supply pipe being open to form a pipe outlet from said supply pipe at the first end of the supply tube assembly, the supply pipe being configured for transporting solid particles carried by a fluid from the second end of the supply tube assembly to the pipe outlet through said supply pipe; at least one inlet connector attached to the supply pipe at the second end of the supply tube assembly and configured to connect at least one supply line to the supply pipe for supplying the solid particles and the carrier fluid into the supply pipe; a ramp arranged inside the supply pipe at the pipe outlet and pivotably arranged such that the inclination of the ramp in relation to the central longitudinal axis is adjustable by pivoting the ramp about a pivot axis which is perpendicular to the central longitudinal axis, the ramp extending from said pivot axis towards the pipe outlet; and adjusting means attached to the ramp for adjusting the inclination of the ramp and for holding the ramp at said inclination.

According to another aspect of the present invention, there is provided a supply device for supplying solid particles and a carrier fluid into a combustion chamber, said combustion chamber being delimited by at least one chamber wall, said supply device comprising: a supply tube assembly according to the above aspect of the invention, said supply tube assembly, led by its first end, extending into the combustion chamber through a through hole in the wall of the combustion chamber; a displacing device adapted for axial displacement of the supply tube assembly along the longitudinal axis and, led by its second end, through the through hole of the chamber wall, the displacing device being arranged to engage with said supply tube assembly at the second end of the supply tube assembly; and a supply line connected to a supply source and to the inlet connector of the supply pipe, the supply line being arranged for supplying the solid particles from the supply source to the supply pipe.

According to another aspect of the present invention, there is provided a method for supplying solid particles in a combustion chamber, the method comprising: providing a supply device according to the above aspect of the invention; supplying the solid particles and the carrier fluid to the supply pipe such that a flow of the solid particles carried by the carrier fluid is formed through the supply pipe and emitted into the combustion chamber from the pipe outlet; and adjusting the inclination of the ramp to control an emission angle of the solid particles as they are emitted from the pipe outlet into the combustion chamber, and to control an exit velocity of the flow at the pipe outlet.

The device aspects above of the present invention may be used for performing the method aspect of the present invention.

By using a pivotable ramp inside the supply tube assembly, at the pipe outlet and extending from the pivot axis towards the pipe outlet, the flow of solid particles and carrier fluid can be affected as they pass the ramp when they flow through the supply pipe, so that the flow direction of at least a part of the flow, and thus a part of the solid particles and a part of the carrier fluid, can be altered by the ramp. How the flow direction is altered depend at least partly on the inclination of the ramp in relation to the central longitudinal axis of the supply tube assembly. The ramp may be solid, not allowing any of the flow to pass through the ramp, but partly penetratable ramps are also contemplated where still at least a part of the flow is diverted, i.e. the direction a part of the flow is altered. Since the ramp is provided at the pipe outlet of the first end of the first end of the supply pipe assembly, the altered flow direction achieved by means of the ramp, also results in an altered emission/exit direction of at least part of the flow from the pipe outlet into the combustion chamber.

Also by means of the pivotable ramp, the flow channel defined by the supply pipe may be more or less blocked by the ramp, depending on to which inclination the ramp is adjusted. If the ramp is not inclined in respect of the longitudinal axis, it blocks the flow in the supply pipe the least, but if it is inclined to the maximum 90 degrees, it is put perpendicular to the flow direction and achieves maximum blockage of the flow channel. However, the ramp may typically be longer than the diameter of the flow channel why it may not be possible to position the ramp at 90 degrees inclination, but it may still be possible to substantially block the flow channel by means of the ramp. A partial blockage of the flow channel results in an increased flow velocity at the place of the blockage without changing the size of the flow. Since the ramp is provided at the pipe outlet of the first end of the first end of the supply pipe assembly, the increased flow velocity at the blockage of the ramp results in an increased exit/emission velocity of the solid particles of the flow. In combination with the altered emission direction, both the exit angle/direction and exit velocity of at least a part of the solid particles may thus be controlled by means of the pivotable ramp. By controlling the exit angle and velocity of the solid particles, the supply tube assembly may be used as a gun or catapult to “shoot” the solid particles to different places within the combustion chamber. It is advantageous to be able to change the place of emission of the fluid and/or solid particles in the combustion chamber since the temperature and compound composition typically varies within the combustion chamber. By adjusting the inclination of the ramp, the exit velocity and angle of the solid particles may be adjusted such that the solid particles are supplied to the desired part of the combustion chamber. This may be particularly convenient in large combustion chambers where the supply tube assembly would have to be inconveniently long to otherwise be able to emit the solid particles to the desired part of the combustion chamber. Typically, the pipe outlet of the supply pipe is arranged such that the flow is emitted in a direction substantially parallel to the central longitudinal axis if the flow is not adjusted by means of the ramp as discussed herein.

By the adjusting means, the inclination of the ramp may be adjusted as needed, and thus the exit angle and velocity of the solid particles as discussed above. The adjusting means is also arranged for holding the ramp in place at the desired inclination of the ramp, i.e. the inclination it has been adjusted to by the adjusting means.

By including a displacing device in the supply device, the supply tube assembly, and with it the pipe outlet, can be moved axially, why the fluid and/or solid particles may be emitted at different places in the combustion chamber. As discussed above, it may be advantageous to be able to adjust where to emit the solid particles and the carrier fluid in the combustion chamber. The displacing device may also allow partly or fully removing the supply tube assembly axially from the combustion chamber through the hole in the wall of the combustion chamber, e.g. for cleaning or maintenance.

The discussions above and below in respect of any of the aspects of the invention is also in applicable parts relevant to any other aspect of the present invention.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

The invention is now described, by way of example, with reference to the accompanying drawings, in which:

FIG. 1 is a schematic side view, partly in section, of an embodiment of a supply device of the present invention and a combustion chamber.

FIG. 2 is a schematic side view in longitudinal section of an embodiment of a supply tube assembly of the present invention.

FIG. 3 is a schematic cross-sectional view of the supply tube assembly of FIG. 2.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

The term “tube” is intended to denote a hollow substantially cylindrical structure being delimited by a lateral surface and first and second end surfaces. The lateral surface is substantially parallel to the central longitudinal axis of the supply tube assembly, whereas the respective end surfaces are substantially not parallel to the central longitudinal axis of the supply tube assembly but intersects the central longitudinal axis of the supply tube assembly. The tube may be a substantially circular tube, i.e. have a substantially circular cross-section perpendicular to the central longitudinal axis, but other shapes are also contemplated, such as a square or rectangular tube. The supply tube assembly has a first end, intended to be the end of the assembly which is inserted the furthest into the combustion chamber, and a second end, intended to be the end inserted the least into the combustion chamber or even extending outside of the combustion chamber. When the supply tube assembly is inserted into the combustion chamber, the first end may be regarded as an inner end since it extends, is inserted, into the combustion chamber, whereas the second end may be regarded as an outer end since it extends through an outer wall of the combustion chamber, such that the second end is in or outside said outer wall.

That something is at the first or second end of the supply tube assembly, such as the displacing device meshing with or engaging the supply tube assembly at its second end, implies that it is at least closer to that end than to the other end.

The supply pipe defines a flow channel for the flow of solid particles and carrier fluid. The flow channel may conveniently have a rectangular, e.g. substantially square, cross-section perpendicular to the longitudinal axis of the supply tube assembly. A rectangular cross-section allows for the ramp being more easily arranged and pivoted in the flow channel and facilitates the blocking of the flow channel by the ramp since the ramp may more easily seal against a flat wall of the pipe. Further, a rectangular flow channel may imply a rectangular profile of the supply pipe. A supply pipe with a rectangular outer cross-section may be convenient if e.g. an outer tube forming an outer lateral surface of the supply tube assembly from the first end to the second end of the supply tube assembly around the supply pipe is used. The outer tube may have a circular cross-section and be supported against the four longitudinal outer edges of the supply pipe formed by the four corners of the rectangular cross-section of the supply pipe, while forming longitudinal cavities which may be used as flow channels between the flat outer walls formed by the four sides of the rectangular cross-section of the supply pipe and the inner wall of the outer tube. Thus, the supply tube assembly may be more rigid than e.g. a similar supply tube assembly having a circular supply pipe and a circular outer tube, while still facilitating a longitudinal flow of e.g. cooling medium between the supply pipe and the outer tube. The pipe outlet of the supply pipe may form a nozzle in an aperture of the outer tube, i.e. an aperture through a wall/surface, typically an end surface, of the outer tube.

The ramp may have an end which is distal to the pipe outlet and an opposite end which is proximal to the pipe outlet, and a longitudinal axis extending between said ends, the angle between the longitudinal axis of the ramp and the longitudinal axis of the supply tube assembly defining the inclination of the ramp. The ramp may be pivotably arranged at its pivot axis by the distal end of the ramp. Thus, the ramp is pivotably arranged/attached at the distal end of the ramp, e.g. allowing the ramp to be pivotably attached to and along an inner wall of the flow channel in the supply pipe. The distal end of the ramp may in parallel to the ramp pivot axis extend along and in contact with an inner wall of the supply pipe, which inner wall is intended to be a lower inner wall of the supply pipe when the supply tube assembly is inserted into the combustion chamber. Typically, the supply tube assembly is horizontally inserted into the combustion chamber. In this way, the ramp may affect a major part, or all, of the solid particles flowing through the supply pipe to control the exit velocity and/or direction (angle in respect of the central longitudinal axis of the supply tube assembly) of said solid particles. Due to gravity, the solid particles may have a higher density in the flow at the lower inner wall of the supply pipe. Also due to gravity, the ramp may have a better controlling affect on where the solid particles are supplied in the combustion chamber since the ramp may act against gravity if pivotably arranged at a lower wall of the supply pipe.

The supply tube assembly may also comprise at least one guiding strip. The guiding strip may extend along the ramp, e.g. substantially parallel to the longitudinal axis of the ramp or at a small angle to the longitudinal axis of the ramp. The guiding strip may be pivotable together with the ramp about the pivot axis of the ramp, e.g. by being in contact with or fastened to the ramp. The guiding strip may be pivotably attached inside the supply pipe such that it is pivotable about a pivot axis which is perpendicular to the pivot axis of the ramp. The guiding strip may e.g. be pivotably attached to the ramp, such as to a side of the ramp facing away from an inner wall of the supply pipe which the distal end of the ramp (mentioned above) extends along and/or is in contact with. A plurality of any such guiding strip may be used. By means of such a guiding strip, the direction of at least a part of a flow through the supply pipe may be altered in a direction different than the direction in which the flow may be altered by the ramp itself. If e.g. the ramp may alter the flow in a substantially vertical direction, the strip(s) may alter the flow in a substantially horizontal direction. The strips may e.g. be regarded as guides on a surface of the ramp along, and possibly in contact with, which surface at least some of the solid particles of the flow travel.

The supply tube assembly may be comprised in a supply device for supplying the solid particles of the flow into a combustion chamber, e.g. of a rotary kiln. When operational, the supply device is arranged with the combustion chamber such that the supply tube assembly extends into the combustion chamber through a through hole of a wall of the combustion chamber. The supply tube assembly may be axially displaceable along its longitudinal axis through the hole such that the supply tube assembly may be fully inserted or fully removed from the combustion chamber, or to any position there between such that the distance which the supply tube assembly extends into the combustion chamber may be controlled. The solid particles may be supplied to the supply tube assembly from a supply source via a supply line and a connector arranged in the supply pipe at the second end of the supply tube assembly. Also the carrier fluid may be supplied, e.g. from a fan or pump for the carrier fluid, via the same supply line and connector or via a separate fluid supply line and connector, whereby the carrier fluid and solid particles are combined in the supply tube assembly, not before.

Since by means of the present invention, solid particles may be shot or catapulted into the combustion chamber, thus extending the reach of the supply tube assembly for supplying the solid particles at a desired place in the combustion chamber, they may conveniently be used for large combustion chambers. The inventor has realised that the present invention may be especially useful for a rotating combustion chamber, such as a rotary kiln. Rotary kilns are used for many applications, e.g. for preparing/heating lime or cement, or any other application where a substance is to be heated in large quantities and preferably continuously, i.e. not batch wise. Due to the rotary movement of the combustion chamber, it may be difficult to provide a supply tube assembly, or any other supply means, through or attached to an inner/outer surface of a lateral wall, i.e. a wall extending along and rotating about the rotary axis of the combustion chamber. However, it may be possible to provide the supply tube assembly through a combustion chamber wall intersecting the rotary axis, conveniently at or close to where the rotary axis is intersected by the wall. Thus, the supply tube assembly may extend into the rotary combustion chamber such that the central longitudinal axis of the assembly is substantially parallel to the rotary axis, close to the rotary axis or even overlap/coincide with the rotary axis. However, a rotary combustion chamber, such as of a rotary kiln, may be very long, e.g. more than 50 or 100 meters, why the shooting/catapulting ability of the present invention may be convenient or even necessary for supplying the solid particles to the desired place within the combustion chamber, e.g. where the temperature is advantageous for supplying the solid particles. For example, for supplying urea for reduced NOx in the exhaust gases, a temperature of between 800 and 1000 degrees C., such as 900° C., may be desired, and the present invention may allow the urea particles to reach the part of the rotary combustion chamber with the desired temperature.

The carrier fluid may be any suitable fluid, such as air or oxygen which may also be used as secondary air/oxygen for the combustion in the combustion chamber.

The solid particles may e.g. comprise an agent for reducing the formation of polluting nitrogen oxides (NOx) or sulphur oxides (SOx) or corrosive compounds such as chlorine salts. Thus, the solid particles may e.g. comprise urea.

The supply tube assembly may be of any size, but it may be convenient to use a supply tube assembly which has a longitudinal length of less than 10 m, such as less than 5 m, in order to reduce the lateral stress on the supply tube assembly, especially if the supply tube assembly is inserted substantially horizontally into the combustion chamber. The diameter of the supply tube assembly may also be of any size, but it may be convenient to use a supply tube assembly with a diameter of less than 250 mm, such as less than 200 mm, less than 150 mm, less than 120 mm or less than 100 mm, in order to reduce the weight of the supply tube assembly to make it more easy to handle and move, axially and/or rotationally around its longitudinal axis. Another advantage with using a smaller supply tube assembly is that less cooling may be needed of the supply tube assembly, since the supply tube assembly takes up heat in relation to its surface area.

Only one supply tube assembly may be used in a combustion chamber, but it may also be convenient to use a plurality of supply tube assemblies, e.g. substantially parallel to each other, at different positions in the combustion chamber. The supply tube assemblies may then co-operate with each other to provide optimal supply of the fluid and/or solid particles in the combustion chamber, e.g. improved mixture of the fluid and/or solid particles with the atmosphere in the combustion chamber and/or improved coverage of the combustion chamber volume by being able to supply the fluid and/or solid particles at more different positions in the combustion chamber.

The supply tube assembly may be inserted into the combustion chamber in any direction. It may be convenient to insert the supply tube assembly vertically, e.g. hanging through the top wall (ceiling/roof) of the combustion chamber in order to reduce the lateral stresses on the supply tube assembly and the mounting of the supply tube assembly in the chamber wall, and/or on the displacing device. On the other hand it may be convenient to insert the supply tube assembly horizontally, e.g. through a side wall of the combustion chamber. Depending on the design on the combustion chamber, it may be easier to reach the place within the combustion chamber where it is desired to supply the fluid and/or solid particles in the combustion chamber with a horizontal supply tube assembly. A vertically inserted supply tube assembly may need to be much longer and heavier in order to reach the same position in the combustion chamber as a substantially smaller horizontally inserted supply tube assembly.

The supply tube assembly of the supply device may be provided with means for supplying a cooling agent to said supply tube assembly. This has the advantage that the supply tube assembly can operate for long periods of time in a very hot environment.

Thus, the supply tube assembly may comprise coolant connectors configured as inlet and outlet of a cooling medium which may circulate in the supply tube assembly, typically between the supply pipe and the outer tube.

The displacing device or means for displacing said supply tube assembly may be arranged so as to permit rotation of the supply tube assembly around its central axis.

The supply device may further comprise cleaning means, e.g. mechanically by means of steel pins or brushes, or pneumatically by means of blowing air or steam for cleaning said supply tube assembly during its axial inward and/or outward movement in the combustion chamber. As the supply tube assembly is subjected to a combustion process, particles, such as e.g. soot, will eventually be formed on the supply tube assembly and also at the aperture/nozzle/outlet. The supply tube assembly will at some point in time need to be withdrawn from the combustion chamber to be cleaned. By this arrangement, the supply tube assembly is cleaned swiftly and can be re-inserted immediately after cleaning.

The supply tube assembly of the supply device may be provided with at least one sensor, e.g. a heat sensor or a camera (e.g. video or infra red camera), arranged to measure at least one parameter in the combustion chamber and the sensor may be operatively connected to a control unit. This may be advantageous in that it allows for continual monitoring of the condition in the combustion chamber and/or the condition of the supply tube assembly in order to continually adapt (amount and/or place of) the supply of fluid and/or solid particles to the combustion chamber. This may be done automatically by the control unit, or by an operator studying the measurements, e.g. via a display of the control unit, and issuing commands to the supply device for movement thereof via e.g. an input unit of the control unit. Thus, the inclination of the ramp, and possibly the guiding strip, may be controlled based on a reading from the sensor, conveniently automatically

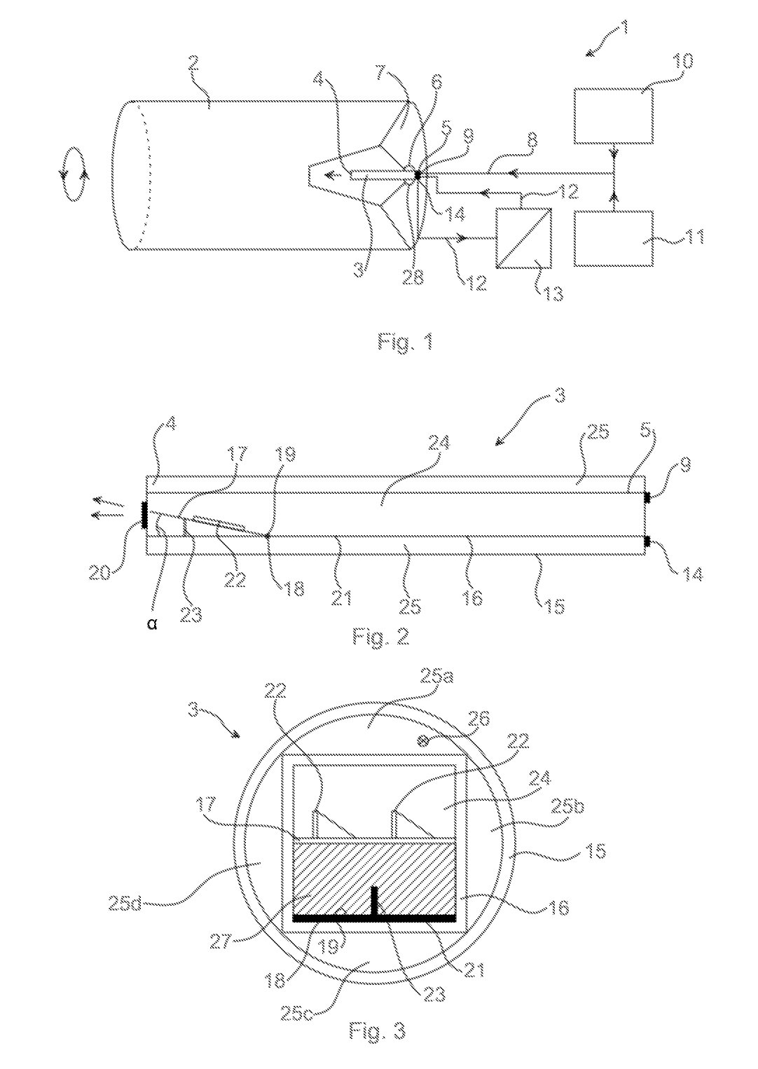

With reference to FIG. 1, an embodiment of a supply device 1 of the present invention arranged with a combustion chamber 2 of a rotary kiln will now be discussed. The combustion chamber 2 is shown partly in section so as to show the supply tube assembly 3 provided therein.

A supply tube assembly 3 is arranged in the combustion chamber 2, with a first end 4 of the supply tube assembly 3 being inserted the furthest into the combustion chamber 2 and a second end 5 of the supply tube assembly 3 being in a through hole 6 through the wall 7 of the combustion chamber 2. The combustion chamber 2 is rotating, as denoted by the circular arrows to the far left in FIG. 1. The supply tube assembly 3 is connected to a supply line 8 via an inlet connector 9 of the supply tube assembly 3 at its second end 5. The supply line 8 is a conduit or duct for transporting solid particles carried by a carrier fluid from a supply source 10, e.g. containing urea pellets, to the supply tube assembly 3 to be emitted into the combustion chamber 2 from the first end 4 of the supply tube assembly 3, as indicated by the arrow in FIG. 1. A fan 11 blows the carrier fluid, e.g. air or oxygen, into the supply line 8, mixing with the solid particles in the supply line 8 and carrying the solid particles along/in the supply line 8. The supply tube assembly 3 is provided with a cooling system such that a coolant circulates in the supply tube assembly 3 and a coolant loop 12, which coolant loop 12 passes through a heat exchanger 13 where the coolant is cooled by means of exchanging heat with a gas, e.g. air, or liquid, e.g. water. The coolant loop 12 is connected to the supply tube assembly 3 via coolant connectors 14, one inlet connector and one outlet connector, for allowing the coolant to circulate through the supply tube assembly 3 and the coolant loop 12. A displacing device 28 is arranged at and engaging the second end 5 of the supply tube assembly 3 for axially displacing the supply tube assembly if desired.

FIG. 2 illustrates an embodiment, in longitudinal side section view, of a supply tube assembly 3, e.g. the supply tube assembly 3 shown in FIG. 1.

The supply tube assembly 3 comprises an outer tube 15 enveloping a supply pipe 16 having the same longitudinal orientation as the outer tube 15. The supply pipe 16 is open to form a pipe outlet 20 at the first end 4 of the supply tube assembly 3. Inside the supply pipe 16, a ramp 17 is provided, pivotably attached to an inner wall of the supply pipe 16 such that the ramp 17 can pivot about a pivot axis 18. The ramp 17 is pivotably attached by a ramp end 19 which is distal to the pipe outlet 20 such that the distal end 19 extends in parallel to the pivot axis 18 of the ramp 17 along and in contact with a lower inner wall 21 of the supply pipe 16. This lower inner wall 21 has its principal extension in a plane perpendicular to the section plane shown in FIG. 2. On the ramp 17, there is provided a guide strip 22 extending along the ramp 17 and being pivotable together with the ramp 17 about the ramp pivot axis 18. The guide strip is pivotably attached to the ramp 17 such that the guide strip is pivotable about a strip pivot axis which is perpendicular to the ramp pivot axis 18. Adjusting means 23 is provided to adjust the inclination α of the ramp 17 relative to the longitudinal axis of the supply tube assembly by pivoting the ramp 17 about its pivot axis 18. The supply tube assembly 3 of FIGS. 1 and 2, as well as the outer tube 15 and the supply pipe 16, is provided substantially horizontally, whereby the central longitudinal axis of the assembly 3 is also substantially horizontal. Thus, a flow of the solid particles and the carrier fluid passing through the supply pipe 16 from the first end 4 to the second end 5 of the supply tube assembly would typically exit the supply tube arrangement through the pipe outlet 20 in a substantially horizontal direction, as indicated by the lower horizontal arrow in FIG. 2. However, by means of the ramp 17, the flow, and especially the particles thereof, may have its direction altered by the ramp such that it acquires an exit angle α relative to the horizontal, as indicated by the upper arrow in FIG. 2. Due to gravity, the particles being emitted into the combustion chamber 2 at an angle to the horizontal, i.e. the longitudinal axis of the supply tube assembly 3, may be shot/catapulted further in a longitudinal direction into the combustion chamber 2. Also, the ramp partially blocks the flow channel 24 formed by the supply pipe 16 and the blockage is increased by an increased inclination α of the ramp 17. Thus, the flow velocity of the solid particles and the carrier fluid is increased at the first end 4 of the supply tube assembly 3 with increased inclination α of the ramp 17. This increased velocity acts synergistically with the altered exit angle of the solid particles to transport the particles longitudinally further into the combustion chamber. According to the embodiment of FIG. 2, the ramp 17 act to alter the flow direction in a vertical direction. To complement this flow direction alteration, the strip 22 may alter at least a part of the flow in a horizontal direction by pivoting about its strip pivot axis. A longitudinal space 25 is formed between the outer tube 15 and the supply pipe 16 longitudinally along the supply tube assembly 3. At least part of this space may form a coolant duct for allowing coolant to circulate through the coolant duct 25 and the coolant loop 12 via the coolant connectors 14 to cool the supply tube assembly 3.

FIG. 3 is a schematic cross-sectional view, transverse of the longitudinal axis, of the supply tube arrangement 3 in FIG. 2, at the first end 4.

According to this embodiment, the supply pipe 16 cross-section is rectangular or square, both its inner and outer wall surfaces, thus defining a flow channel 24 having a rectangular cross-section. Thus, the supply pipe 16 may support the outer tube 15 against the corners of the rectangular supply pipe 16, thus providing a more rigid and stress resistant supply tube assembly 3, while still providing longitudinal ducts 25a-d in the supply tube assembly 3 between the outer tube 15 and the supply pipe 16. These ducts 25 may be used for a coolant medium as discussed above. Coolant may e.g. travel from the second end 5 to the first end 4 of the supply tube assembly 3 in one of the ducts 25 and from the first end 4 to the second end 5 in another of the ducts 25, or additional coolant pipes may be arranged in one or several of the ducts for guiding the coolant. However, an additional advantage of using a rectangular supply pipe 15 is that a plurality of separate longitudinal ducts 25 may be formed. Thus, one of the ducts 25, e.g. the duct 25a which is above the supply pipe 15 and thus might be subjected to less heat than the other ducts 25, may be allowed to form a duct for another flowing medium, e.g. another agent to be supplied to the combustion chamber, or it may be filled with air.

In the embodiment of FIG. 3, a sensor 26, such as a camera, is arranged in the duct 25a to film and survey the combustion chamber. The sensor may be connected to a control unit and the sensor readings may form basis for the adjusting of the ramp 17 and/or the strip(s) 22 for altering the flow direction as discussed above. As can be seen in FIG. 3, the ramp 17 is inclined in respect of the longitudinal axis of the supply tube assembly and partly blocks the flow channel 24. This has been emphasised by marking the underside 27 of the ramp 17 with diagonal lines. Again, the distal end 19 of the ramp 17 is attached to the supply pipe such that said distal end 19 extends at and in parallel to the ramp pivot axis 18 along and in contact with the flat lower inner wall 21 of the supply pipe 16. The adjusting means 23 is in this embodiment arranged between and in contact with the underside 27 of the ramp 17 and the lower inner wall 21 of the supply pipe 16. The adjusting means 23 may e.g. be a hydraulic or pneumatic device attached to the lower inner wall 21 and pushing on the underside 27, or the adjusting means 23 may be a string or wire, or such, attached to the underside 27 such as it is may be pulled towards the lower inner wall 21, such that the ramp 17 is pivoted about its pivot axis 18. Atop the ramp 17, two guiding strips 22 are arranged as also discussed above. In FIG. 3 it can be seen that the guiding strips 22 are pivoted somewhat to the left in the figure so as to guide a part of the flow to the left, while the inclined ramp 17 guides the flow upwards.

According to one embodiment of the present invention, there is provided a supply tube assembly (3) having a central longitudinal axis, a first end (4) and a second end (5) and comprising: a supply pipe (16) extending in parallel with the central longitudinal axis from the second end of the supply tube assembly to the first end of the supply tube assembly, the supply pipe being open to form a pipe outlet (20) at said first end, the supply pipe being configured for transporting solid particles carried by a fluid from said second end to the pipe outlet; and a ramp (17) arranged inside the supply pipe at the pipe outlet and pivotably arranged such that the inclination (a) of the ramp in relation to the longitudinal axis is adjustable by pivoting the ramp about a pivot axis (18) which is perpendicular to the central longitudinal axis, the ramp extending from said pivot axis towards the pipe outlet. The invention further relates to a supply device comprising the supply tube assembly and to a method of a combustion chamber.

The invention has mainly been described above with reference to a few embodiments. However, as is readily appreciated by a person skilled in the art, other embodiments than the ones disclosed above are equally possible within the scope of the invention, as defined by the appended patent claims.

1. A supply tube assembly for supplying solid particles to a combustion chamber, said supply tube assembly having a central longitudinal axis, a first end and a second end, the supply tube assembly comprising:
a supply pipe extending in parallel with the central longitudinal axis from the second end of the supply tube assembly to the first end of the supply tube assembly, the supply pipe being open to form a pipe outlet from said supply pipe at the first end of the supply tube assembly, the supply pipe being configured for transporting solid particles carried by a fluid from the second end of the supply tube assembly to the pipe outlet through said supply pipe;
at least one inlet connector attached to the supply pipe at the second end of the supply tube assembly and configured to connect at least one supply line to the supply pipe for supplying the solid particles and the carrier fluid into the supply pipe;
a ramp arranged inside the supply pipe at the pipe outlet and pivotably arranged such that the inclination of the ramp in relation to the central longitudinal axis is adjustable by pivoting the ramp about a pivot axis which is perpendicular to the central longitudinal axis, the ramp extending from said pivot axis towards the pipe outlet; and
adjusting means attached to the ramp for adjusting the inclination of the ramp and for holding the ramp at said inclination.

2. The supply tube assembly of claim 1, wherein the supply pipe defines a flow channel having a rectangular cross-section.

3. The supply tube assembly of claim 1, wherein the ramp is pivotably arranged at the pivot axis by an end of said ramp which is distal to the pipe outlet of the supply pipe.

4. The supply tube assembly of claim 3, wherein said end of the ramp extends, parallel to the pivot axis of the ramp, along and in contact with an inner wall of the supply pipe, which inner wall is arranged to be a lower inner wall of the supply pipe when the supply tube assembly is in use.

5. The supply tube assembly of claim 1, further comprising an outer tube forming an outer lateral surface of the supply tube assembly from the first end to the second end of the supply tube assembly around the supply pipe, the pipe outlet of the supply pipe forming a nozzle in an aperture of the outer tube.

6. The supply tube assembly of claim 5, further comprising coolant connectors configured as inlet and outlet of a cooling medium to circulate in the supply tube assembly between the supply pipe and the outer tube.

7. The supply tube assembly of claim 1, further comprising at least one guiding strip, extending along said ramp and being pivotable together with the ramp about the pivot axis of the ramp as well as being pivotably attached inside the supply pipe such that it is pivotable about a pivot axis which is perpendicular to said pivot axis of the ramp.

8. A supply device for supplying solid particles and a carrier fluid into a combustion chamber, said combustion chamber being delimited by at least one chamber wall, said supply device comprising:
a supply tube assembly according to claim 1, said supply tube assembly, led by its first end, extending into the combustion chamber through a through hole in the wall of the combustion chamber;
a displacing device adapted for axial displacement of the supply tube assembly along the longitudinal axis and, led by its second end, through the through hole of the chamber wall, the displacing device being arranged to engage with said supply tube assembly at the second end of the supply tube assembly; and
a supply line connected to a supply source and to the inlet connector of the supply pipe, the supply line being arranged for supplying the solid particles from the supply source to the supply pipe.

9. The supply device of claim 8, wherein the combustion chamber is a combustion chamber of a rotary kiln.

10. A method for supplying solid particles in a combustion chamber, the method comprising:
providing a supply device according to claim 8;
supplying the solid particles and the carrier fluid to the supply pipe such that a flow of the solid particles carried by the carrier fluid is formed through the supply pipe and emitted into the combustion chamber from the pipe outlet; and
adjusting the inclination of the ramp to control an emission angle of the solid particles as they are emitted from the pipe outlet into the combustion chamber, and to control an exit velocity of the flow at the pipe outlet.

11. The method of claim 10, further comprising:
obtaining a measurement from a sensor comprised in the supply device and mounted on the supply tube assembly; and
basing the adjusting of the inclination of the ramp on said measurement.
